(19) United States
(12) Patent Application Publication
(10) Pub. No.: US 2003/0095260 A1
(43) Pub. Date: May 22, 2003

(54) Illuminating apparatus for optical test

(76) Inventors: Kenji Yoneda, Kyoto (JP); Takashi Sugita, Kyot (JP); Shigeki Masumura, Kyoto (JP)

Correspondence Address: Kirschstein, Ottinger,, Israel & Schiffmiller, P.C., 489 Fifth Avenue, New York, NY, 10017-6105, US

(21) Appl. No.: 10/295,145

(22) Filed: Nov. 15, 2002

(30) Foreign Application Priority Data
Nov. 16, 2001 (JP) 2001-352453

(51) Int. Cl. G01N 21/47

(52) U.S. Cl. 356/446

(57) ABSTRACT

To provide an illuminating apparatus for surface testing which can illuminate every spot uniformly without causing a dark spot.

An illuminating apparatus for optical test comprises: a plurality of illuminating units 3 each include linear light sources 14 each having a plurality of light-emitting members aligned and also include light-converging means 16 on the light-emitting side of the linear light sources 14, and the light-emitting members of said plurality of illuminating units 3 are disposed in such a manner that the linear light sources 14 illuminate nearly the same spots of a test object and that the light-emitting members VL1 of one of said plurality of illuminating units 3 illuminate different spots of the test object from the light-emitting members VR1 of another one of said plurality of illuminating units 3 in the longitudinal direction of the linear light-emitting members.

### BACKGROUND OF THE INVENTION

1. Field of the invention

The present invention relates to an illuminating apparatus for optical test, which is used in a factory or similar places to examine the external appearance or defects of a product as the test object by checking the beams of light applied to the product and reflected therefrom, or which is used to check the conditions of soldering of electronic components mounted on a printed circuit board. It also relates to an illuminating apparatus for optical test, which is used to detect foreign matters from a test object made of a semitransparent material such as plastic or paper by applying light beams to the test object and checking the light beams passed through the test object.

2. Description of the Background Art

The above-mentioned illuminating apparatus for optical test will be described intelligibly by referring to FIG. 1 of the present invention. Two substrates 15L, 15R each have three rows of linear light sources 14, 14, 14 in the longitudinal direction (in the drawing, in the direction perpendicular to the paper), and the linear light sources 14, 14, 14 on the substrate 15L contain a number of light-emitting diodes VL1, VL2, and VL3, respectively, and the linear light sources 14, 14, 14 on the substrate 15R contain a number of light-emitting diodes VR1, VR2, and VR3, respectively. A pair of first illuminating units 3, 3 are arranged in the form of an inverted V when seen from a side and each has three cylindrical lenses 16, 16, 16 for converging beams of light in the form of belts on the light-emitting side of the three linear light sources 14, 14, 14 with a pair of supporting plates 16A disposed therebetween. This configuration enables an uneven surface like a soldered spot to be securely tested by applying light beams to the test object from a slanting direction.

The installment position of the light-emitting diodes VL1, VL2, and VL3 in one first illuminating unit 3 in the longitudinal direction is the same as the installment position of the light-emitting diodes VR1, VR2, and VR3 in the other first illuminating unit 3 in the longitudinal direction when the latter illuminating unit 3 is seen from the former illuminating unit 3, and this causes the following inconveniences.

In the above configuration, as shown in FIG. 14, the beams of light H1 emitted from the light-emitting diodes VL1, VL2, and VL3 and the beams of light H2 emitted from the light-emitting diodes VR1, VR2, and VR3 impinge on the same spots, causing dark spots B not illuminated between the beams of light from light-emitting diodes adjacent in the longitudinal direction (in the drawing, the top and the bottom between the beams of light), thereby making it impossible to test the spots properly. Even if a number of light-emitting diodes are tightly disposed with little space therebetween, the above-mentioned inconveniences cannot be solved, showing room for improvement.

### SUMMARY OF THE INVENTION

In view of the aforementioned situation, the present invention has the object of providing an illuminating apparatus for optical test, which can illuminate a test object uniformly without causing a dark spot.

In order to solve the aforementioned problems, the present invention provides an illuminating apparatus for optical test, wherein the apparatus comprises a plurality of illuminating units, each of the units includes linear light sources each consisting of a plurality of light-emitting members aligned one after another and also includes light-converging means on the light-emitting side of the linear light sources, and each of the light-emitting members of each of said plurality of illuminating units are disposed in such a manner that all the linear light sources illuminate substantially the same line on a surface of a test object from different positions and that the illumination of the light-emitting members of said each of the units geometrically shifted in complemented manner from that of the light-emitting members of another one of said units in the direction of said substantial same line.

The beams of light from the plurality of illuminating units are converged by the light-converging means such as cylindrical lenses, converted into a belt of light beams, and applied to nearly the same spots of the test object. The beams of light from the light-emitting members in the plurality of illuminating units are illuminated as shown in FIG. 4. To be more specific, the beams of light H2 from the light-emitting members of an illuminating unit are applied in a partly superimposed manner between the nearly circular beams of light H1, H1 emitted from the light-emitting members in another illuminating unit, thereby forming a belt of beams of light (the area surrounded by dots). This provides almost uniform intensity over the entire area, eliminating the dark spots B, B shown in FIG. 14. The beams of light H3, H4 shown in FIGS. 4 and 14, which develop on both sides of the beams of light H1, H2, are not used for optical test this area, but actually the belt of beams of light H1, H2 is used for optical test. It is possible that the beams of light reflected from the test object are taken by an imaging means such as a line sensor camera or the like and the taken images are tested automatically by providing an image processor. In some cases, it is also possible to make a virtual inspection from above the half mirror. The illuminating apparatus for optical test of the present invention is suitable to examine a test object by reflected beams of light, but can be also used to detect foreign matters by making beams of light penetrate into a test object made from paper, plastic, or the like and detecting foreign matters from the penetrated beams of light. In FIG. 1 the three rows of illuminating units are provided on both sides of the perpendicular line T, or a normal plane extending through the drawing paper, perpendicular to the test surface (front surface) of the test object so as to obtain larger amount of light than the cases with one or two rows of illuminating units; however, it is possible to provide one or two rows of illuminating units or four or more rows of illuminating units to increase the amount of light. When plural rows of illuminating units are provided, the light-emitting members are so arranged that the illuminated positions (constituting the illuminated line) by the light-emitting members in all the illuminating units are sifted from each other in the longitudinal direction of the aligned light-emitting members, thereby further increasing the effect of providing uniform intensity in the entire area in the longitudinal direction. Instead of this arrangement, it is possible to arrange all the light-emitting members in such a manner that the illuminated positions by the light-emitting members in a certain illuminating unit differ from the illuminated positions of the light-emitting members in the remaining illuminating units. As means for making the illuminated positions different from each other, it is possible that the pitches of the light-emitting members of all the illuminating units are made the same, and some or all of the illuminating units are displaced in such a manner that the illuminated positions of the light-emitting members of some or all of the illuminating units differ from each other in the direction of arranging the light-emitting members (in the longitudinal direction of the light-emitting members). It is also possible to make the pitches between the light-emitting members of an illuminating unit different from the pitches between the light-emitting members of the other illuminating units so that the illuminated positions of the light-emitting members of some or all of the illuminating units differ from the illuminated positions of the light-emitting members of the other illuminating units in the direction of arranging the light-emitting members.

The plurality of illuminating units are divisionally arranged into both sides of a normal plane of said substantial same line on the surface of the test object so as to illuminate substantially the same line on the surface of the test object from slanting directions.

The divisional plurality of illuminating units on one side includes the linear light sources arranged to illuminate substantially the same line on the surface of the test object. As a result, the amount of illuminated light can be increased.

The light-emitting members constituting one of the linear light sources have the same aligned pitch with that of the other of the linear light sources, and the illumination of the light-emitting members of the one linear light source are geometrically shifted in complemented manner from that of the light-emitting members of the other of the linear light sources. As a result, the light-emitting members of the illuminating units on one side illuminate different spots on the target line of the test object in the direction of arranging the light-emitting members from the light-emitting members of the illuminating units on the other side. Hence the light-emitting members of the illuminating units emit light beams in a partly superimposed manner.

Adopting light-emitting diodes or chip-type light-emitting diodes as the light-emitting members is more advantageous in terms of power consumption and heat generation than the cases adopting various kinds of lamps. And an additional advantage of this structure is to have a dramatically long life and slower degenerating speed. Adopting lamp-type light-emitting diodes has the advantage of converging light more effectively by using light-converging means than in the case with chip-type light-emitting diodes.

Another illuminating apparatus of the invention further comprises: a second illuminating unit composed of at least one second linear light source aligned to be substantially parallel with the arrangement direction of said plurality of the light-emitting members; and a half mirror, said second linear light source including a plurality of light-emitting members and light-converging means, which illuminates, via the light-converging means a half mirror disposed above a space between the illuminating units equally divided into both sides so as to illuminate the test object positioned below, by the reflected light from the half mirror along the normal plane to the test object through the space.

According to the above-described configuration, the beams of light from the second illuminating unit are converged by light-emitting means such as cylindrical lenses, converted into a band of light beams, and applied to the test object in the perpendicular direction, which enables a flat surface to be tested properly.

Another illuminating apparatus for optical test of the invention comprises: a plurality of first illuminating units each including linear light sources, each of the light sources having a plurality of light-emitting members aligned one after another, and the each unit also including light-converging means on the light-emitting side of the linear light source thereof, said plurality of first illuminating units being equally divided to both sides of a normal plane to the surface of a test object so as to illuminate substantially the same line on the surface of the test object from different slanting directions; and at least one second illuminating unit composed of at least one second linear light source including a plurality of light-emitting members aligned to be substantially parallel with the arrangement direction of the light-emitting members of said first units, which illuminates, via light-converging means, a half mirror disposed above a space between the illuminating units equally divided into both sides so as to illuminate the test object positioned below, by the reflected light from the half mirror along the normal plane to the test object through the space, and the illumination of the light-emitting members constituting at least one of the first illuminating units being geometrically shifted in comb-likely complicated manner from that of the second illuminating unit in the direction of said substantial same line.

Consequently, the beams of light from the light-emitting members of the illuminating units and the beams of light from the light-emitting members of the second illuminating unit can be emitted in a partly superimposed manner by making the light-emitting members of a part (specific) or all of the illuminating units illuminate different spots of the test object from the light-emitting members of the second illuminating unit. In addition, the beams of light from the light-emitting members of the illuminating units can be emitted in a partly superimposed manner by making the light-emitting members of a part (specific) of the illuminating units illuminate different spots of the test object from the light-emitting members of the remaining illuminating units. Furthermore, in the case where the second illuminating units are provided in plural rows, the beams of light from the light-emitting members of the second illuminating units can be emitted in a partly superimposed manner by making the light-emitting members of a part of the second illuminating units illuminate different spots of the test object from the light-emitting members of the remaining second illuminating units.

The illuminating apparatus may comprise a diffusing plate disposed between the light-converging means and the test object in order to diffuse the beams of light from the light-emitting members.

Since the beams of light are converged by the light-converging means, of the beams of light from the light-emitting members of the plurality of illuminating units arranged at different angles, the regular-reflected strong beams of light from the light-emitting members of a specific illuminating unit (beams of light near the light axes of the light-emitting members) can be taken into the imaging means, but the regular-reflected strong beams from the light-emitting members of the other illuminating units cannot be taken by the imaging means, thereby reducing the intensity of the beams of light to be taken in spite of the provision of the plurality of illuminating units. However, providing the diffusing plate as described above enables the beams of light from the light-emitting members of the other illuminating units that have not been able to be taken into the imaging means to be taken in, thereby brightening the beams of light to be taken into the imaging means.

The plurality of illuminating units may be divided into both sides of a normal plane to the illuminated surface of a test object while providing a space between the divided illuminating units, and the beams of light emitted from the illuminating units and then reflected by the surface of the test object are passed through the space between the divided illuminating units and optically recognized.

An illuminating apparatus for optical test can comprise: light-converging means disposed on the light-emitting side of linear light sources each having a number of light-emitting members aligned; and a diffusing means disposed before or behind the light-converging means for diffusing the beams of light from the linear light sources in the direction of arranging the light-emitting members.

Providing the diffusing means before or behind the light-converging means causes the beams of light from the light-emitting members to be diffusing in the direction of arranging the light-emitting members before or after being converged and can solve the phenomenon that, for example, when the light sources are directly applied as the backlights or regular-reflected on the coated surface of a test object having a coated surface, the spheres of the light-emitting members such as light-emitting diodes are seen directly, thereby cutting the beams of light between the light-emitting members. To be more specific, as shown in FIG. 20(a), in the case where the test object 1 is made of paper, when the beams of light h which are emitted from the light-emitting diodes 25 to illuminate the paper 1 and reflected are seen by the naked eye I, the spheres of the light-emitting diodes 25 are not directly seen, and instead, the beams of light h can be seen in the form of a belt. On the other hand, as shown in FIG. 20(c), in the case where the test object 1 is of specular surface, there is a phenomenon that the spheres of the light-emitting diodes 25 can be seen directly when seen by the naked eye I, thereby cutting the beams of light between the light-emitting diodes 25. This phenomenon can be solved by providing the diffusing means. As shown in FIG. 20(b), in the case where the light sources are directly applied as the backlight, the diffusing means 28 composed of a diffusing plate can be utilized to make the spheres of the light-emitting diodes 25 look like a belt composed of lined spheres instead of lumpy conditions shown in FIG. 20(c). In this case, a single illuminating unit can be provided or a plurality of illuminating units can be provided to increase brightness. The diffusing means can have a surface provided with a plurality of convex portions of various kinds which are along the direction orthogonal to the direction of arranging the light-emitting members and which are formed in the direction of arranging the light-emitting members, or can be composed of a diffusing member such as an optical fiber housed in a transparent member. The light-converging means are not illustrated in FIGS. 20(a), 20(b), and 20(c).

### BRIEF DESCRIPTION OF THE DRAWINGS

FIG. 1 is a vertical cross sectional view of an illuminating apparatus for optical test.

FIG. 2 is a view showing the configuration of the main part of the attachment unit of the light-emitting diodes and cylindrical lenses.

FIG. 3 is a view showing an arrangement of the light-emitting diodes of the illuminating apparatus shown in FIG. 1.

FIG. 4 is a view showing another arrangement of the light-emitting diodes.

FIG. 5 is a view showing an image sample of the beams of light emitted by the light-emitting diodes of the first illuminating units shown in FIG. 1.

FIG. 6 is a vertical cross sectional view of another illuminating apparatus for optical test equipped with a diffusing plate.

FIG. 7 is a FIG. 7 Views showing different arrangement of the imaging means and the light-emitting diodes; (a) shows the case with no diffusing plate, and (b) shows the case with a diffusing plate.

FIG. 8 is a vertical cross sectional view of another illuminating apparatus for optical test.

FIG. 9 is a plan view of another illuminating apparatus for optical test.

FIG. 10 is a vertical cross sectional view of another illuminating apparatus for optical test.

FIG. 11 is a view showing an arrangement of the light-emitting diodes of the illuminating apparatus of FIG. 8.

FIG. 12 is a view showing another arrangement of the light-emitting diodes of the illuminating apparatus of FIG. 8.

FIG. 13 is a view showing an image sample where the beams of light from the first illuminating units and the beams of light from the second illuminating unit superimpose each other.

FIG. 14 is Views showing another illuminating apparatus for optical test; (a) is a cross section cut in the direction of arranging the light-emitting diodes, and (b) is a cross section cut in the direction orthogonal to the arrangement direction of the light-emitting diodes.

FIG. 15 is a cross sectional view showing the illuminating apparatus of FIG. 14 provided with three diffusing plates.

FIG. 16 is a cross sectional view of another diffusing plate.

FIG. 17 is a cross sectional view of another diffusing plate.

FIGS. 18(a), (b) , (c) are cross sectional views of other diffusing plates.

FIG. 19 is a view showing an image sample of the beams of light applied by the illuminating unit for optical test shown in FIG. 14.

FIGS. 20(a), (b), (c) show the conditions of light when seen from the light-emitting diodes.

FIG. 21 is a view showing an image sample of the beams of light emitted by a conventional illuminating unit.

### DESCRIPTION OF THE PREFERRED EMBODIMENTS

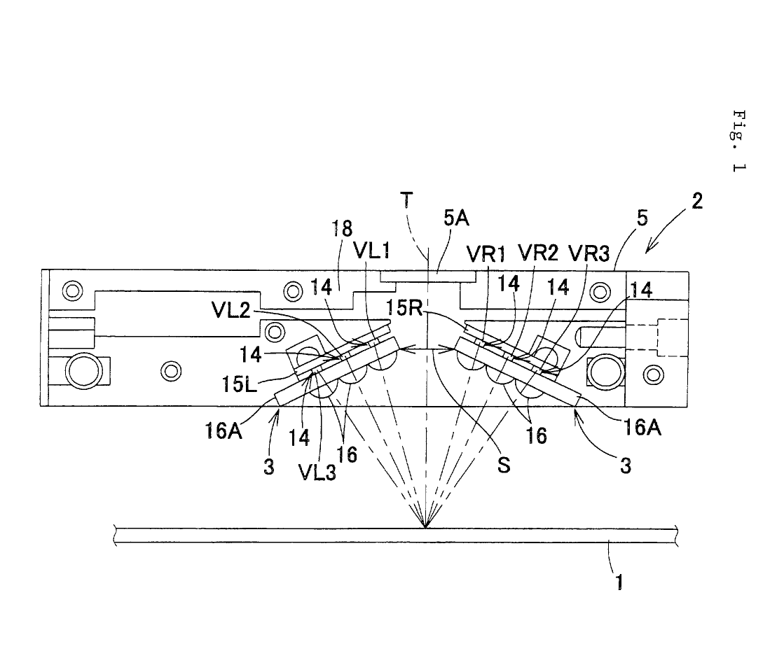

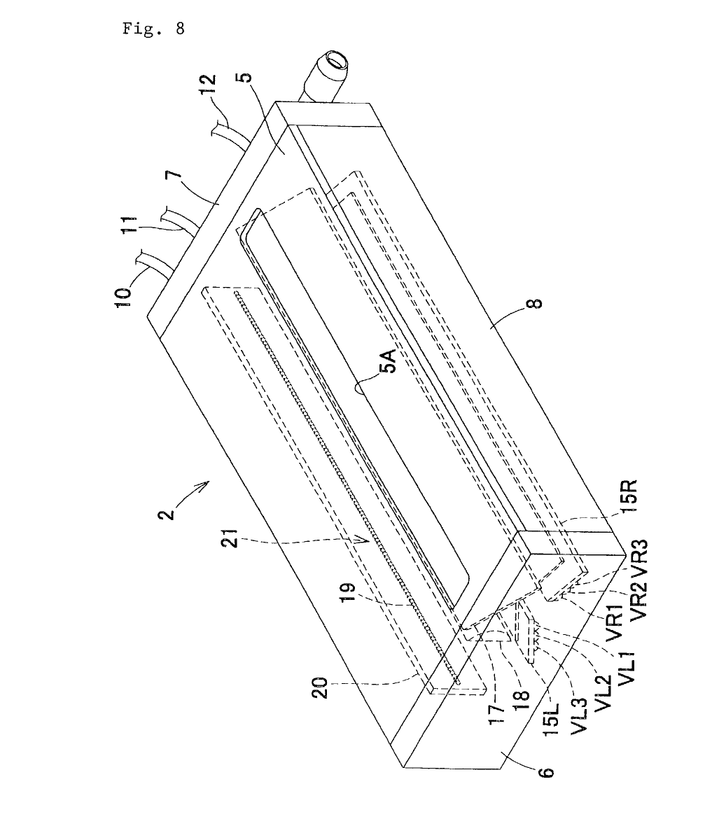

FIG. 1 shows an illuminating apparatus for optical test, which illuminates and examines the surface irregularities or unillustrated soldered spots of the printed circuit board 1 as the test object. The illuminating apparatus for optical test comprises a rectangular box-shaped casing 2 with an open bottom and two (or more than two) first illuminating units 3 housed in the casing 2. The two first illuminating units 3 are divided into both sides of the perpendicular line T which is perpendicular to the flat test surface (front surface) of the printed circuit board 1 so as to illuminate nearly the same spots on the printed circuit board 1 from different slanting directions. The illuminating apparatus for optical test shown here performs testing by taking in the light reflected from the surface of the test object; however, other than this type, it can be an illuminating apparatus for optical test which is used to detect foreign matters from a test object made of a transparent or semitransparent material by taking in the light penetrated into the test object. It is possible that the light reflected from the test object is taken by a line sensor camera (not shown) disposed above the long hole 5A (refer to FIG. 8) of the top plate unit 5; the obtained image is processed by an unillustrated image processor; and the conditions of the processed image can be checked by a computer or can be shown on a monitor to be examined by the naked eye. In some designs, the test object can be visually checked by omitting the line sensor camera.

As shown in FIG. 1, the first illuminating units 3, 3 are arranged with a space S therebetween which is nearly the same size as the width of the long hole 5A (the size in the direction perpendicular to the longitudinal direction) in such a manner that the illuminating units 3, 3 are lowered as they get farther from the space S, in other words, in the form of an inverted V when seen from a side. Since the first illuminating units 3, 3 have the same structure, the first illuminating unit 3 on one side will be exclusively explained as follows. The first illuminating unit 3 is composed of a substrate 15L mounting three rows of first linear light sources 14, 14, 14 each containing a large number of three kinds of light-emitting diodes VR1, VR2, and VR3 arranged in a slanting direction with a predetermined space therebetween, and the large number of three kinds of light-emitting diodes VR1, VR2, and VR3 are aligned in the direction perpendicular to the paper in FIG. 1 (the other substrate 15R contains light-emitting diodes VR1, VR2, and VR3). The first illuminating unit 3 is further composed of three cylindrical lenses (any kind will do, as long as they can converge light beams) 16, 16, 16 which are nearly parallel to the light-emitting diodes VL1, VL2, and VL3 and which are provided on the light-emitting side of the three linear light sources 14, 14, 14 as light-converging means with a supporting plate 16A disposed therebetween. The three cylindrical lenses 16, 16, 16 and the supporting plate 16A can be formed integrally.

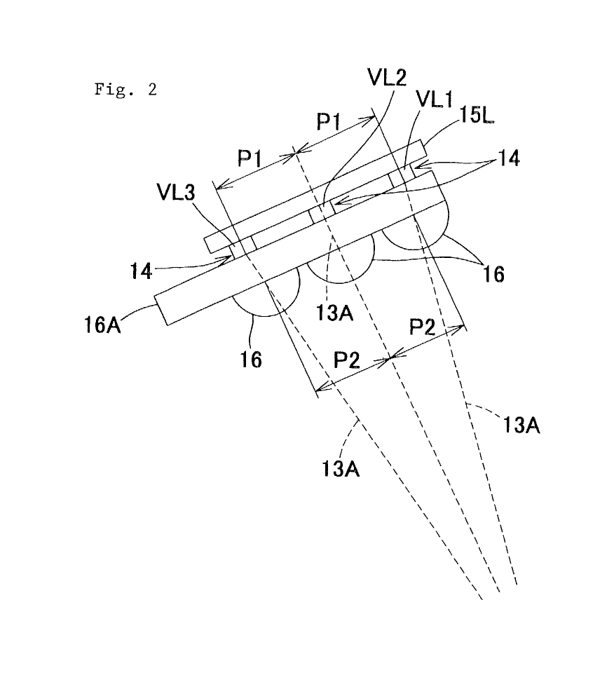

As shown in FIG. 2, the light axis 13A of the light-emitting diodes VL2 of the first linear light source 14 arranged in the center of the three rows of first linear light sources 14, 14, 14 is coincided with the center of the cylindrical lens 16 arranged to correspond to the light axis 13A. The light axes 13A, 13A, 13A from the three cylindrical lenses 16, 16, 16 can be focused by making the distance P2 between the cylindrical lens 16 in the center and the cylindrical lenses 16, 16 on both sides (the pitches between the cylindrical lenses 16, 16) smaller than the distance PI between the first linear light source 14 arranged in the center and the two rows of light-emitting diodes VL1, VL3 disposed on both sides (the pitches between the first linear light sources 14, 14). Instead of this arrangement, it is possible that the light-emitting diodes VL1, VL2, and VL3 and the cylindrical lenses 16, 16, 16 are in the same physical relation, and that the angles of the light-emitting diodes VL1, VL3 and the cylindrical lenses 16, 16 on both sides are changed with respect to the light-emitting diodes VL2 and the cylindrical lens 16 disposed in the center, thereby focusing the light axes 13A, 13A, 13A from the three cylindrical lenses 16, 16, 16. In this case, each of the light-emitting diodes VL1, VL2, and VL3 may be provided with its own substrate 15L.

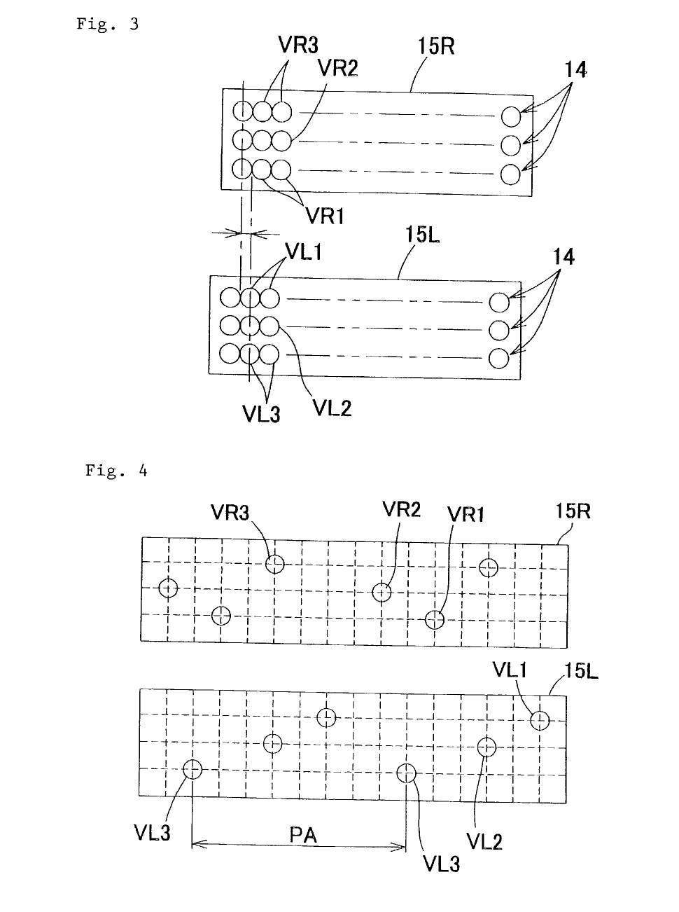

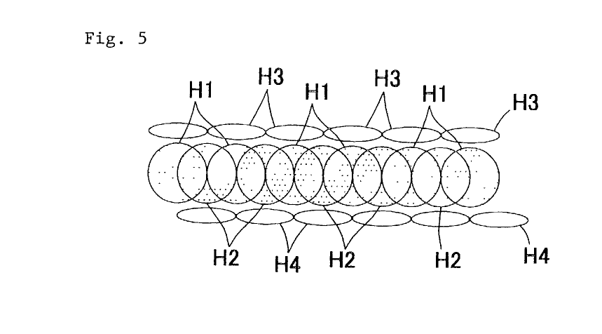

The arrangement of light-emitting diodes VL1, VL2, VL3, VR1, VR2, and VR3 put in the same attachment positions by the same pitch is shown in FIG. 3, and the conditions of the light beams emitted by these light-emitting diodes VL1, VL2, VL3, VR1, VR2, and VR3 are shown in FIG. 5. The beams of light H2 applied to the test object from the light-emitting diodes VR1, VR2, and VR3 arranged in the longitudinal direction of the three rows of first linear light sources 14 attached on the right-side substrate 15R (illustrated at the top in FIG. 3) are made to superimpose with each other between the beams of light H1, H1 applied to the test object from the light-emitting diodes VL1, VL2, and VL3 adjacent in the longitudinal direction of the three rows of the first linear light sources 14 attached on the left-side substrate 15L (illustrated at the bottom in FIG. 3). This arrangement is achieved by positioning the left-side substrate 15L and the right-side substrate 15R with a space therebetween corresponding to half of the pitch (distance) between the light-emitting diodes 13, 13 when the substrate 15R is seen from the substrate 15L so as to enable the beams of light to be evenly emitted in the form of a belt without any dark spot. In FIG. 3 the left- and right-side substrates 15L, 15R are displaced from each other. Instead of this arrangement, the light-emitting diodes VL1, VL2, and VL3 in the substrate 15L can be different in attachment positions from the light-emitting diodes VR1, VR2, and VR3 in the substrate 15R so as to emit the beams of light evenly in the form of a belt without causing dark spots. Although the first linear light sources 14 are in three rows in the drawing, it is possible to provide the first linear light sources in a single, double, four, or more rows. Instead of attaching the first linear light sources 14 in plural rows on the same substrate 15L or 15R, each row can be attached to a separate substrate.

The light-emitting diodes VL1, VL2, VL3, VR1, VR2, and VR3 can be arranged as shown in FIG. 4. On the left-side substrate 15L (illustrated at the bottom in FIG. 4), the light-emitting diodes VL1, VL2, and VL3 are fixed at the same pitch PA and different in position in the direction orthogonal to the arrangement direction of the light-emitting diodes (the longitudinal direction of the light-emitting diodes). In the same manner, on the right-side substrate 15R (illustrated at the top in FIG. 4), the light-emitting diodes VR1, VR2, and VR3 are fixed at the same pitch PA and different in position in the direction orthogonal to the direction of arranging the light-emitting diodes. Although the light-emitting diodes VL2 and VR3 are in the same position in the direction orthogonal to the direction of arranging the light-emitting diodes (longitudinal direction of the light-emitting diodes), they could be made different from each other.

Arranging the light-emitting diodes VL1, VL2, VL3, VR1, VR2, and VR3 as above enables almost all of the light-diodes to be fixed in different positions with only a few overlaid ones when the right-side light-emitting diodes VR1, VR2, and VR3 are seen from the left-side light-emitting diodes VL1, VL2, and VL3. This hence allows the beams of light from the light-emitting diodes VL1, VL2, VL3, VR1, VR2, and VR3 to be partly superimposed. For example, the light-emitting diodes VL2 and VL3 can be superimposed, or the light-emitting diodes VL3 and VR1 can be superimposed. Although the light-emitting diodes are illustrated with a large space therebetween in order to make their arrangement easily understandable, they are actually arranged tightly as shown in FIG. 3 when seen by the naked eye.

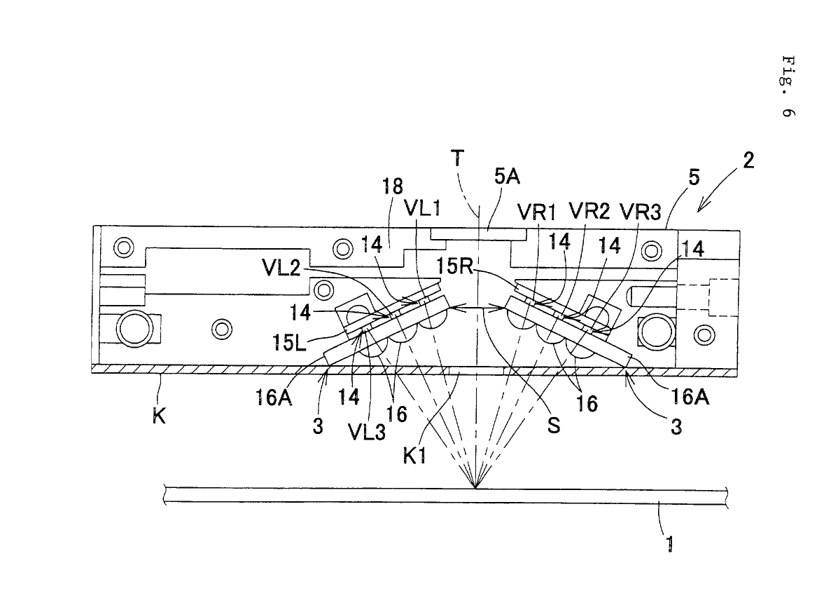

As shown in FIG. 6 it is possible to provide the diffusing plate K which has a through-hole K1 for passing the beams of light reflected from the printed circuit 1 and which is formed around the center of the bottom-side opening of the casing 2 so as to reduce unevenness in emitting the beams of light from the light-emitting diodes VL1, VL2, VL3, VR1, VR2, and VR3, thereby taking the beams of light reflected from the printed circuit 1 into the imaging means as nearly along the perpendicular line T as possible. Supposing that the provision of the diffusing plate K reduces the intensity almost to half, six rows of light-emitting diodes VL1, VL2, VL3, VR1, VR2, and VR3 can obtain only the intensity corresponding to three rows of light-emitting diodes; however, being able to take the reflected beams of light into the imaging means as nearly along the perpendicular line T as possible becomes advantageous in term of unevenness in emitting and intensity of the beams of light to be taken in, as compared with the case without the diffuse plate K. In addition, making the diffusing plate K thin and positioning it as close to the printed circuit board 1 as possible is more advantageous in terms of unevenness in emitting and intensity of the beams of light to be taken in. Although attachment positions are partly superimposed between the left-side light-emitting diodes VL1, VL2, and VL3 and the right-side light-emitting diodes VR1, VR2, and VR3 when the latter group of diodes are seen from the former group of diodes, almost all of the diodes are arranged in different positions, which is advantageous in terms of unevenness in emission. The diffusing plate K is disposed horizontally while the light-emitting diodes VL1, VL2, VL3, VR1, VR2, and VR3 are disposed in slanting directions; however, the diffusing plate K can be disposed in slanting directions so as to be parallel with these light-emitting diodes VL1, VL2, VL3, VR1, VR2, and VR3.

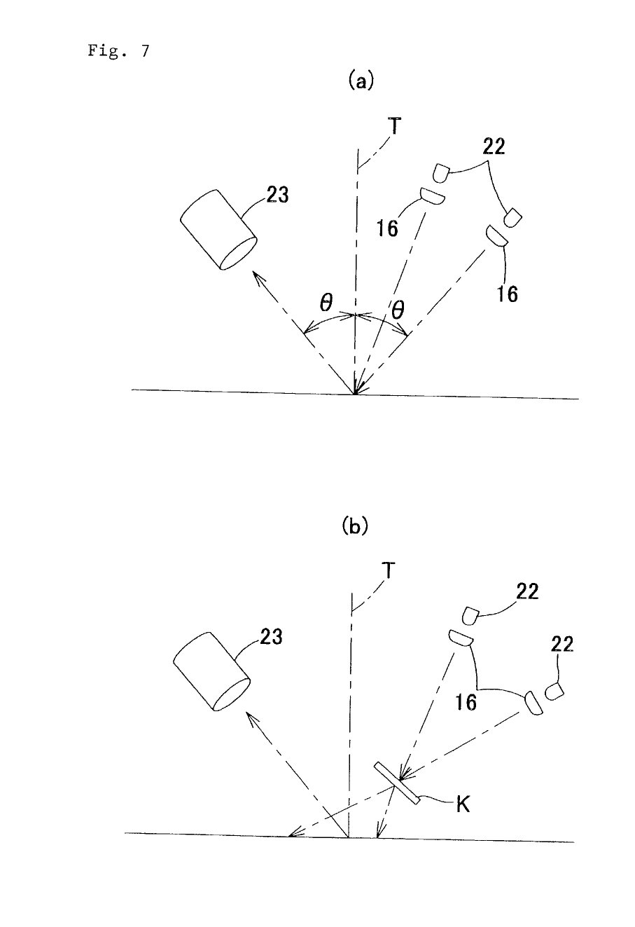

The difference between the case with the diffusing plate K and the case without the diffusing plate K will be briefly described as follows. As shown in FIG. 7(a), an imaging means 23 is provided on the left side at the angle θ from the perpendicular line T which is perpendicular to an unillustrated test object. And two rows of linear light sources (two rows are shown to simplify the explanation, but a single row or more than two rows can be provided instead) containing a number of light-emitting diodes 22, 22 in the direction perpendicular to the paper are arranged on the right side of the drawing, and cylindrical lenses 16 are arranged on the light-emitting side of these linear light sources. In the drawing, the right-side linear light source is arranged on the right side at the angle 0 from the perpendicular line T. Therefore, of the beams of light emitted on the flat test surface from the light-emitting diodes 22, 22, only the beams of light directly reflected by the right-side light-emitting diodes 22 (regular-reflected light) are taken in the imaging means 23, and the beams of light directly reflected by the left-side light-emitting diodes 22 (regular-reflected light) are not taken in. As a result, the imaging means 23 can take in the beams of light from only one linear light source, thereby causing dark spots. In contrast, as shown in FIG. 7(b) , providing the diffusing plate K allows the beams of light from all the linear light sources to be reflected on the imaging means to some degrees, thereby eliminating the occurrence of dark spots as in FIG. 7(a). The larger the linear light sources in number, the more conspicuous effects of providing the diffusing plate K appear. FIGS. 5, 13, and 14 do not show the beams of light directly reflected by the linear light sources (regular-reflected light), but show the beams of light diffused on the surface of the printed circuit board 1.

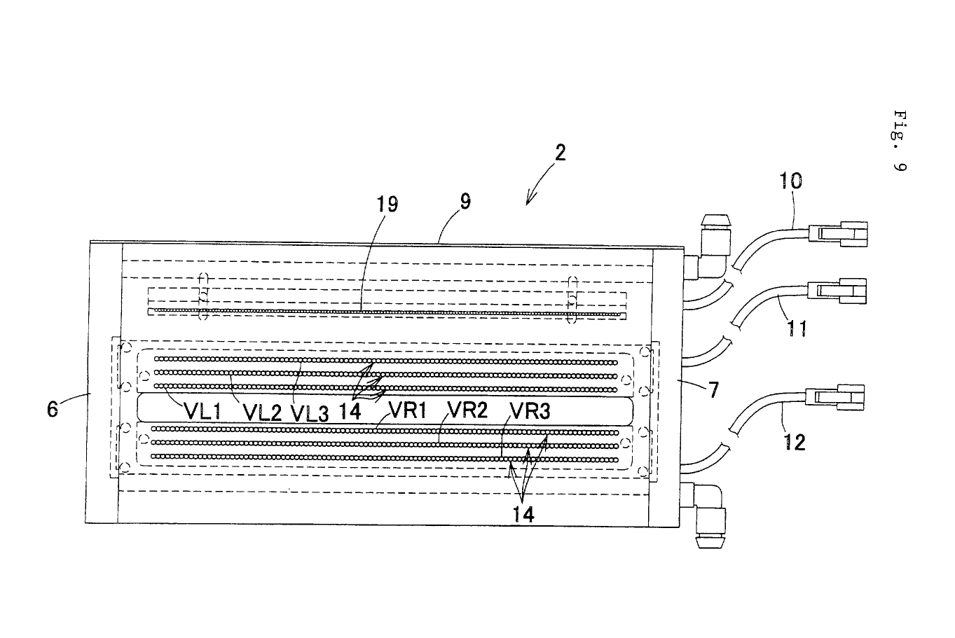

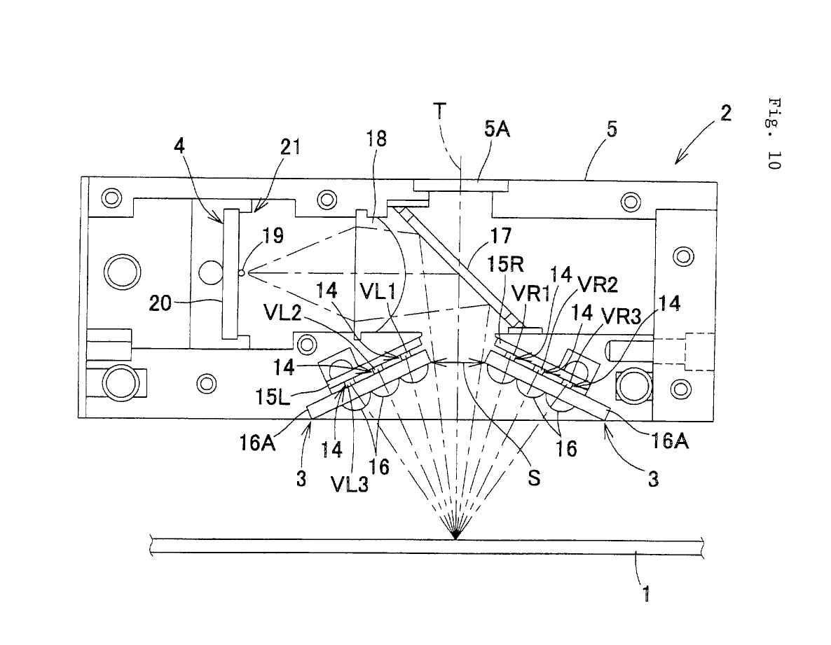

The illuminating apparatus for optical test shown in FIG. 1 is composed only of the first illuminating units 3, 3 with the advantage of achieving downsizing; however, as shown in FIGS. 8 to 10, the second illuminating unit 4 can be additionally provided. The illuminating apparatus for optical test is composed of a rectangular box-shaped casing 2 with an open bottom; two (or more than two) first illuminating units 3 divided into both sides of the perpendicular line T which is perpendicular to the test surface of the printed circuit board 1 so as to illuminate nearly the same spots on the printed circuitboard 1 from different slanting directions; and the second illuminating unit 4 housed in the casing 2. The casing 2 is composed of a top plate unit 5 having the long hole 5A for optical test formed in the center both in the left-and-right direction and the fore-and-aft direction; a left-and-right plate units 6, 7 for covering the left and right sides, and the fore-and-aft plate units 8, 9 for covering the front and back sides; however, it can be composed otherwise. The cables 10, 11, and 12 shown in FIGS. 8 and 9 supply electric power to the first illuminating units 3, 3 and the second illuminating unit 4. This apparatus contains the pair first illuminating units 3, 3 and the second illuminating unit 4; however, only the pair first illuminating units 3, 3 can be provided by omitting the second illuminating unit 4.

As described earlier, it is possible that the light reflected from the test object is taken by a line sensor camera (not shown) disposed above the long hole 5A of the top plate unit 5; the obtained image is processed by an unillustrated image processor; and the conditions of the processed image can be checked by a computer or can be shown on a monitor to be examined by the naked eye. In some designs, the test object can be visually checked by omitting the line sensor camera.

As shown in FIG. 11, on the left-side substrate 15L (illustrated at the bottom in FIG. 11), the light-emitting diodes VL1, VL2, and VL3 are fixed at the same pitch PA and different in position in the direction orthogonal to the direction of arranging the light-emitting diodes. In the same manner, on the right-side substrate 15R (illustrated at the top in FIG. 11), the light-emitting diodes VR1, VR2, and VR3 are fixed at the same pitch PA and different in position in the direction orthogonal to the direction of arranging the light-emitting diodes. Although the light-emitting diodes VL2 and VR3 are in the same position in the direction orthogonal to the direction of arranging the light-emitting diodes, they could be made different from each other.

Arranging the light-emitting diodes VL1, VL2, VL3, VR1, VR2, and VR3 as above enables almost all of the light-diodes to be fixed in different positions with only a few overlaid ones when the right-side light-emitting diodes VR1, VR2, and VR3 are seen from the left-side light-emitting diodes VL1, VL2, and VL3. This hence allows the beams of light from the light-emitting diodes VL1, VL2, VL3, VR1, VR2, and VR3 to be partly superimposed. For example, the light-emitting diodes VL2 and VL3 can be superimposed, or the light-emitting diodes VL3 and VR1 can be superimposed. The light-emitting diodes 19 of the second illuminating unit 4 (shown in the form of squares to be easily distinguished from the light-emitting diodes of the first illuminating units) shown in FIG. 11 have the same pitch as the light-emitting diodes VL1, VL2, VL3, VR1, VR2, and VR3, but can have a different pitch.

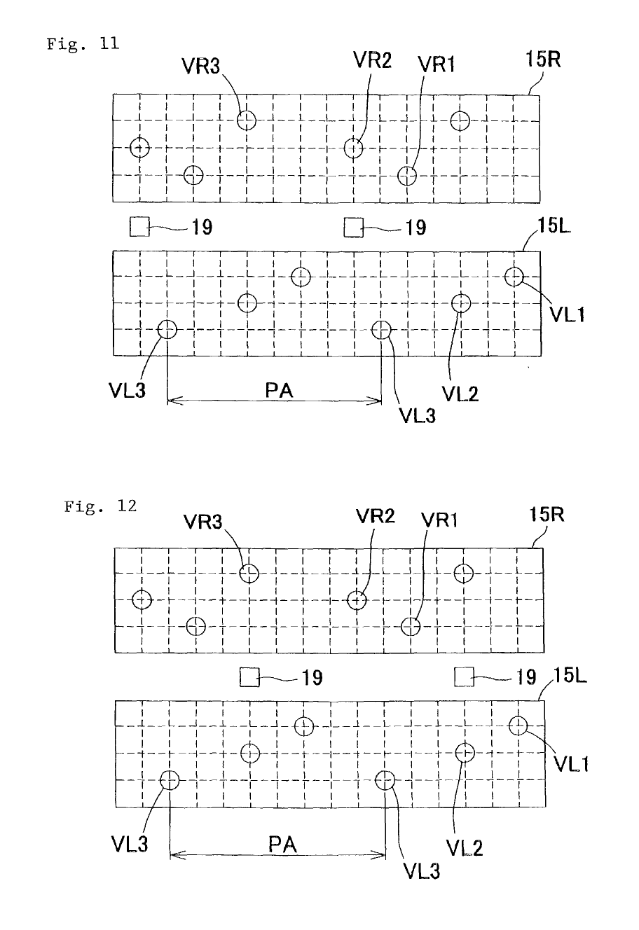

In FIG. 12, the light-emitting diodes VL1, VL2, VL3, VR1, VR2, and VR3 of the first illuminating unit 3 are the same as those in FIG. 11 except that the attachment positions of the light-emitting diodes 19 of the second illuminating unit 4 are changed (the diodes 19 are shown in the form of squares to be easily distinguished from the light-emitting diodes of the first illuminating unit).

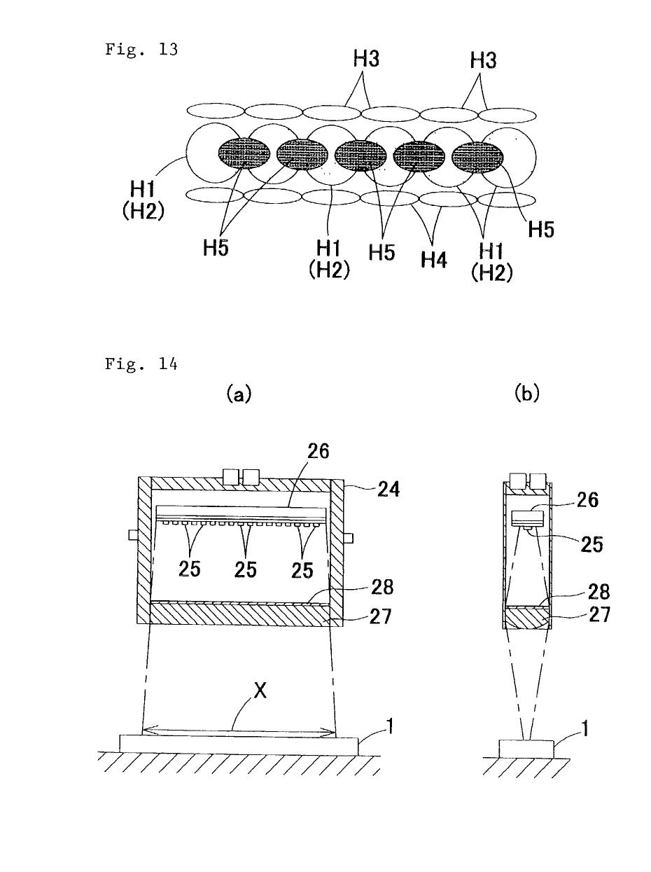

It is possible that the attachment position of the light-emitting diodes VL1, VL2, VL3, VR1, VR2, and VR3 is set the same in the direction orthogonal to their direction of arrangement so that the beams of light from all the light-emitting diodes VL1, VL2, VL3, VR1, VR2, and VR3 impinge on the same spots, thereby making the illumination position of the light-emitting diodes VL1, VL2, VL3, VR1, VR2, and VR3 different from the illumination position of the light-emitting diodes 19 of the second illuminating unit 4 in the direction of arranging the light-emitting diodes. In this case, as shown in FIG. 13, the beams of light H5 of the light-emitting diodes 19 are emitted between the beams of light H1 (H2) and H1 (H2) of the light-emitting diodes VL1, VL2, VL3, VR1, VR2, and VR3 in a superimposed manner to keep dark spots from being produced.

The second illuminating unit 4 is so designed as to apply light beams onto the test object 1 disposed below through the space S between the pair first illuminating units 3, 3 from the direction perpendicular to the test object 1. To be more specific, as shown in FIGS. 8 to 10, the unit 4 is composed of a half mirror 17 disposed above the space S or below the long hole 5A; a cylindrical lens 18 as a light-converging means (any kind will do as long as they can converge light); and a second linear light source 21 containing a number of light-emitting diodes 19, which illuminate the half mirror 17 via the cylindrical lens 18 disposed therebetween, and which are aligned via a substrate 20 to be almost parallel to the direction of arranging the light-emitting diodes 13. In the drawings, the light-emitting diodes 19 are provided in a single row, but they could be provided in plural rows.

As the light-emitting diodes 13, lamp-type light-emitting diodes are effective for light converging; however, chip-type light-emitting diodes, which can increase the packing density, are also usable.

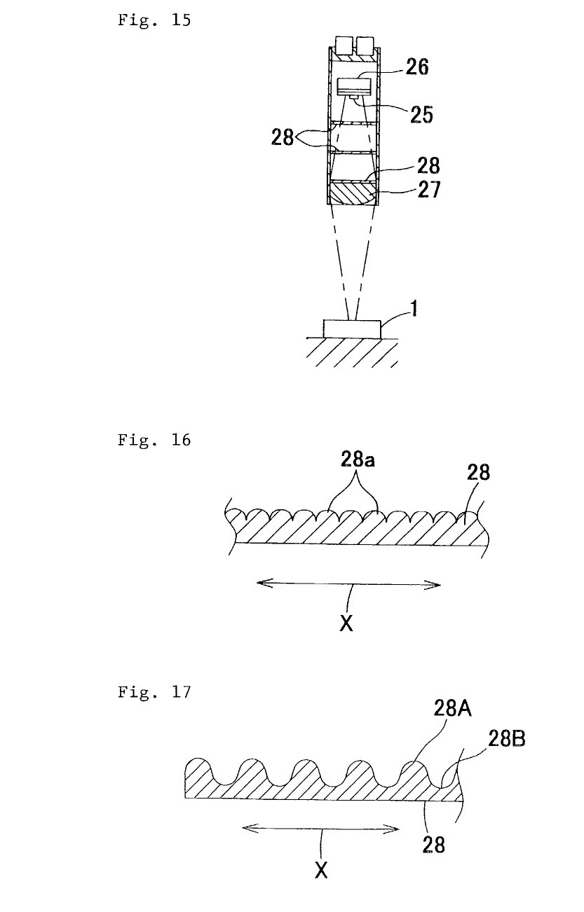

The illuminating apparatus for optical test could be structured as shown in FIGS. 14(a) and 14(b). To be more specific, the box-shaped casing 24 with an open side houses a substrate 26 which supports a number of light-emitting diodes 25 aligned at the regular intervals, a diffusing plate (it can be composed of a transparent acrylic plate or a sheet) as diffusing means for diffusing the beams of light from the light-emitting diodes 25 in the direction X of arranging the light-emitting diodes 25, and a cylindrical lens 27 as light-converging means disposed at the open end of the casing 24 to converge diffused beams of light at the diffusing plate 28. The diffusing plate 28 is disposed behind the cylindrical lens 27, that is, close to or in contact with the back (rear) surface on the light-emitting diodes 25 side. Instead of this arrangement, as shown in FIG. 15, it is possible to dispose the diffusing plate 28 in a position other than the back (rear) surface of the cylindrical lens 27 on the light-emitting diodes 25 side (although the drawing shows three positions including the back surface, it can be other position). The diffusing plate 28 can be disposed before the cylindrical lens 27, and in some cases two can be disposed before and behind the cylindrical lens 27. The transmittance of the diffusing plate 28 is preferably set at 80% or higher in order to prevent a decrease in intensity due to light transmittance.

As shown in FIG. 16, the diffusing plate 28 is composed of a number of convex portions 28a having a semicircular cross section which are formed on the surface (top surface) impinged by the beams of light from the light-emitting diodes 25 in the direction X of arranging the light-emitting diodes 25. The convex portions 28a are formed to be long shaped in the direction (orthogonal to the paper) orthogonal to the direction X of arranging the light-emitting diodes 25. The light entering from the light-emitting diodes 25 (light incident from below in the drawing) into the diffusing plate 28 thus structured is diffused from the surface towards the direction X for arrangement. As the above-mentioned concave-convex form, it is possible to arrange convex portions 28A having a wave-like or semicircular cross section and concave portions 28B having a semicircular cross section alternately in the direction X for arrangement as shown in FIG. 17.

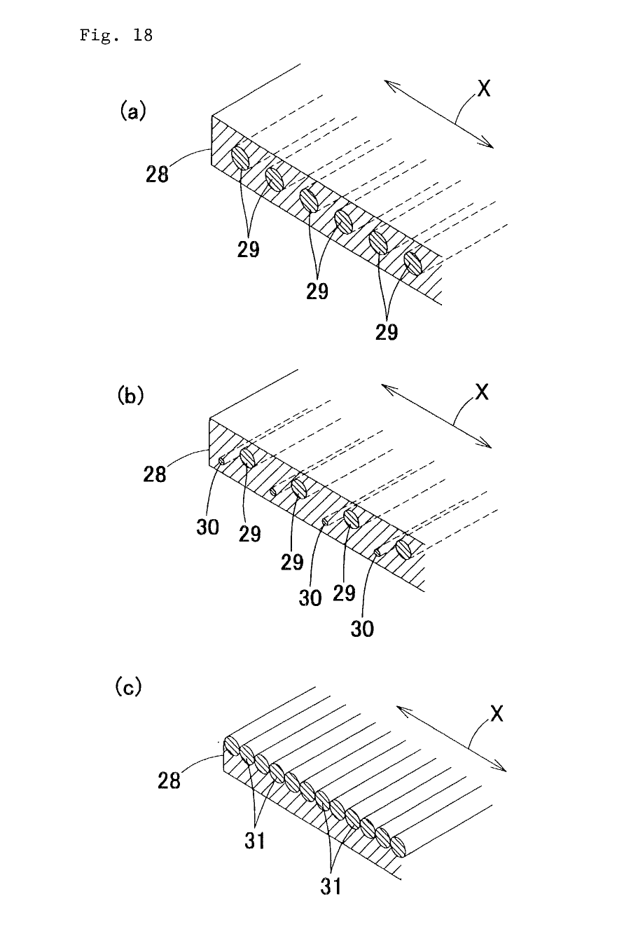

As the diffusing means, a number of concave portions of various shapes which are aligned along the direction orthogonal to the direction X of arranging the light-emitting diodes 25 can be formed on the surface (the surface on the light incident side) of the diffusing plate 28 in the direction X of arranging the light-emitting diodes 25. As another case, as shown in FIG. 18(a), the diffusing plate 28 can be composed of the cylindrical diffusing members 29 (any shape will do) such as optical fibers disposed at regular intervals in the direction X of arranging the light-emitting diodes 25 inside the transparent member. FIG. 18(b) shows a diffusing plate 28 having another kind (it can be more than one kind) of diffusing members having a different diameter in addition to the diffusing members 29 shown in FIG. 18(a) held inside the transparent member. In other words, the diffusing plate 28 is composed of two kinds of diffusing members 29, 30 arranged alternately in the direction X of arranging the light-emitting diodes 25. FIG. 18 (c) shows the diffusing plate 28 composed of diffusing members 31 having a cylindrical shape (any shape will do) like optical fibers which are disposed so tightly each other as to have no space therebetween under the conditions that parts of the diffusing members are exposed on the surface (top surface).

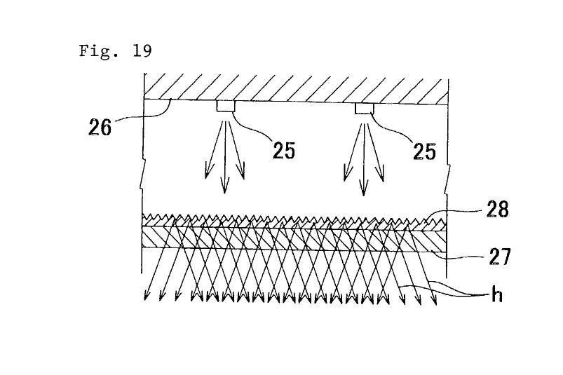

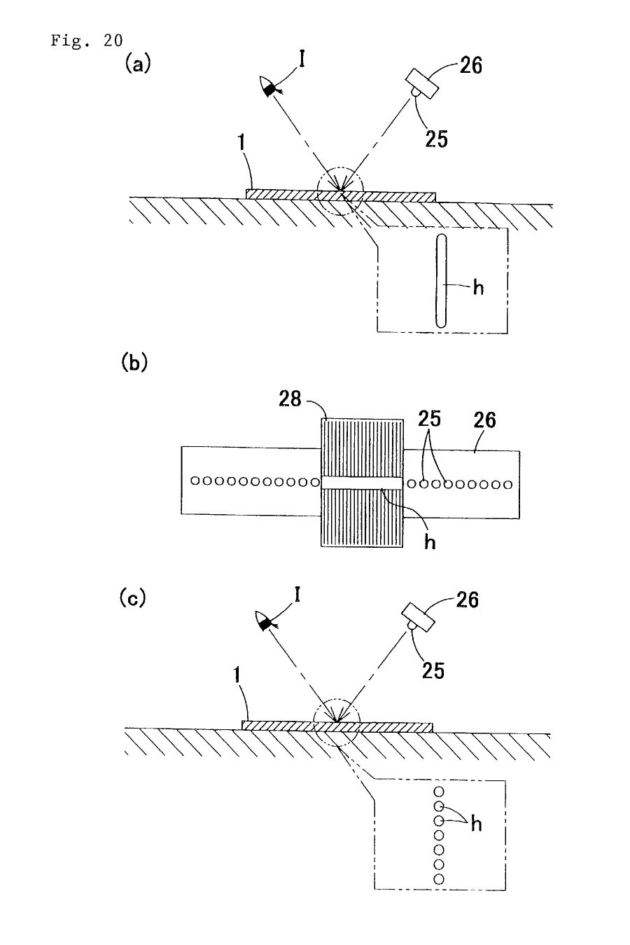

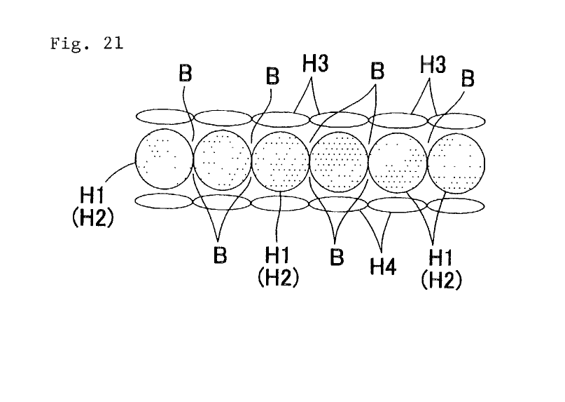

Using the diffusing plates 28 of FIGS. 16 to 18 enables the beams of light h applied from the light-emitting diodes 25 on the test object 1 via the cylindrical lens 27 to be diffused as shown in FIG. 19. When the light source is directly applied as the backlight as shown in FIG. 20(b) or when the light is regular-reflected on the coated surface of the test object 1 having a coated surface as shown in FIG. 20(c), it becomes possible to solve the phenomenon that the spheres of the light-emitting diodes 25 are seen directly to cut the beams of light between the light-emitting diodes 25, 25. FIG. 20(c) shows a comparative example which does not use the diffusing plate 28 for illumination.

The diffusing plate (means) 28 can be provided in the illuminating apparatus for optical test shown in FIGS. 1 and 8. In the cases shown in FIGS. 1 and 8, as described above, the light-emitting diodes VL1, VL2, VL3, VR1, VR2, and VR3 of the illuminating units 3, 3 are disposed in such a manner that the light-emitting diodes VL1, VL2, and VL3 of one illuminating unit 3 illuminate different spots on the test object 1 in the longitudinal direction of the aligned light-emitting diodes from the light-emitting diodes VR1, VR2, and VR3 of the other illuminating unit 3. This brings about the advantage (effect) of uniform illumination without causing dark spots, and the advantage can be increased by the multiplier effect with the diffusion by the diffusing plate 28.

[Effects of the Invention]

The first constitution of the invention provides an illuminating apparatus for optical test, which can properly test a test object having a non-flat surface such as a soldered spot by using a plurality of illuminating units to illuminate the test object with a belt of light beams. It is also possible to provide an illuminating apparatus for optical test, which can illuminate the entire area uniformly without causing dark spots only by changing the illumination positions of the plurality of illuminating units. The illuminating apparatus for optical test can offer the same effects when foreign matters are examined by taking the beams of light passed through a test object.

As another constitution of the invention, light-converging means is disposed on the light-emitting side of linear light sources each having a number of light-emitting members aligned; and diffusing means for diffusing the beams of light from the linear light sources in the direction of arranging the light-emitting members is disposed before or behind the light-converging means. As a result, it becomes possible to solve the phenomenon that when the light sources are directly applied as the backlights or regular-reflected on the coated surface of a test object having a coated surface, the spheres of the light-emitting members such as light-emitting diodes are seen directly to cut the beams of light between the light-emitting members. Thus, in the same manner as in the first constitution, there is an effect of illuminating the entire area uniformly without causing dark spots. There is another effect of offering the above effect only by providing the diffusing means to a conventional illuminating apparatus for optical test, without changing the arrangement of the illuminating units as in the first constitution.

According to the third constitution of the invention, the linear light sources are arranged in such a manner that out of the plurality of illuminating units equally divided to both sides, the illuminating units divided to one side illuminate nearly the same spots of the test object. This configuration increases the amount of light and becomes advantageous in testing minor defects which are likely to be overlooked, thereby extending the range of the test object.

According to a further constitution of the invention, light-emitting diodes or chip-type light-emitting diodes are adopted as the light-emitting members. This is advantageous in terms of power consumption and heat generation than the cases adopting various kinds of lamps. And an additional advantage of this structure is to have a dramatically long life and slower degenerating speed. Furthermore, chip-type light-emitting diodes can have higher packing density than lamp-type light-emitting diodes, thereby further increasing the effect of making the intensity uniform on the entire area.

According to yet further constitution of the invention, the provision of the second illuminating unit enables the illumination of the test object in the perpendicular direction, thereby allowing a flat test surface to be tested properly. The combined use of the second illuminating unit and the pair illuminating units can provide an illuminating apparatus for optical test which provides proper testing to test objects of any shapes. This structure becomes advantageous in detecting foreign matters by taking light beams passed through the test object.

According to yet further constitution of the invention, similar to the aforesaid constitution of the invention, the provision of the second illuminating unit enables the illumination of the test object in the perpendicular direction, thereby allowing a flat test surface to be tested properly, and the combined use of the second illuminating unit and the pair illuminating units can provide an illuminating apparatus for optical test which provides proper testing to test objects of any shapes. Furthermore, there is another advantage of enhancing flexibility in the design of the illuminating apparatus for optical test by achieving uniform illumination across the area without causing dark spots in the same manner as in claim 1 by changing the arrangement of the light-emitting members of the illuminating units, changing the arrangement of the light-emitting members of the second illuminating unit, or changing the arrangement of the light-emitting members of both the illuminating units and the second illuminating unit. These structures become advantageous in detecting foreign matters by taking the light beams passed through the test object.

According to yet another constitution of the invention, the provision of the diffusing plate between the light-converging means and the test object to diffuse the beams of light from the light-emitting members has the advantage of increasing the testing precision by taking the beams of light which used to fail to be taken from the illuminating units. The more the illuminating units in number, the more amount of light can be taken.

What is claimed is:

1. An illuminating apparatus for optical test, wherein the apparatus comprises a plurality of illuminating units, each of the units includes linear light sources each consisting of a plurality of light-emitting members aligned one after another and also includes light-converging means on the light-emitting side of the linear light sources, and the light-emitting members of each of said plurality of illuminating units are disposed in such a manner that all the linear light sources illuminate substantially the same line on a surface of a test object from different positions and that the illumination of the light-emitting members of said each of the units are geometrically shifted in complemented manner from that of the light-emitting members of another one of said units in the direction of said substantial same line.

2. The illuminating apparatus for optical test of claim 1, wherein said plurality of illuminating units are divisionally arranged into both sides of a normal plane of said substantial same line on the surface of the test object so as to illuminate substantially the same line on the surface of the test object from slanting directions.

3. The illuminating apparatus for optical test of claim 2, wherein the divisional plurality of illuminating units on one side includes the linear light sources arranged to illuminate substantially the same line on the surface of the test object.

4. The illuminating apparatus for optical test of claim 1, wherein the light-emitting members constituting one of the linear light sources have the same aligned pitch with that of the other of the linear light sources, and the illumination of the light-emitting members of the one linear light source are geometrically sifted in complemented manner from that of the light-emitting members of the other of the linear light sources.

5. The illuminating apparatus for optical test of claim 1, wherein the light-emitting members are light-emitting diodes or chip-type light-emitting diodes.

6. The illuminating apparatus for optical test of claim 2, further comprising: a second illuminating unit composed of at least one second linear light source aligned to be substantially parallel with the arrangement direction of said plurality of the light-emitting members; and a half mirror, said second linear light source including a plurality of light-emitting members and light-converging means, which illuminates, via the light-converging means a half mirror disposed above a space between the illuminating units equally divided into both sides so as to illuminate the test object positioned below, by the reflected light from the half mirror along the normal plane to the test object through the space.

7. The illuminating apparatus for optical test of claim 1, further comprising a diffusing plate disposed between the light-converging means and the test object in order to diffuse the beams of light from the light-emitting members.

8. An illuminating apparatus for optical test comprising: a plurality of first illuminating units each including linear light sources, each of the light sources having a plurality of light-emitting members aligned one after another, and the each unit also including light-converging means on the light-emitting side of the linear light source thereof, said plurality of first illuminating units being equally divided to both sides of a normal plane to the illuminated surface of a test object so as to illuminate substantially the same line on the surface of the test object from different slanting directions; and at least one second illuminating unit composed of at least one second linear light source including a plurality of light-emitting members aligned to be substantially parallel with the arrangement direction of the light-emitting members of said first units, which illuminates, via light-converging means, a half mirror disposed above a space between the illuminating units equally divided into both sides so as to illuminate the test object positioned below, by the reflected light from the half mirror along the normal plane to the test object through the space, and the illumination of the light-emitting members constituting at least one of the first illuminating units being geometrically shifted in comb-likely complicated manner from that of the second illuminating unit in the direction of said substantial same line.

9. The illuminating apparatus for optical test of claim 8, further comprising a diffusing plate disposed between the light-converging means and the test object in order to diffuse the beams of light from the light-emitting members.

10. The illuminating apparatus for optical test of claim 1, wherein the plurality of illuminating units are divided into both sides of a normal plane to the surface of a test object while providing a space between the divided illuminating units, and the beams of light emitted from the illuminating units and then reflected by the surface of the test object are passed through the space between the divided illuminating units and optically recognized.

11. An illuminating apparatus for optical test comprising: light-converging means disposed on the light-emitting side of linear light sources each having a number of light-emitting members aligned one after another; and a diffusing means disposed before or behind the light-converging means for diffusing the beams of light from the linear light sources in the direction of arranging the light-emitting members.
